(19) United States
(12) Patent Application Publication
(10) Pub. No.: US 2020/0197251 A1
(43) Pub. Date: Jun. 25, 2020

(54) THERAPY APPARATUS AND METHOD OF USE FOR KNEE EXTENSION

(71) Applicant: K. Donald Shelbourne, M.D., LLC, Indianapolis, IN (US)

(72) Inventor: K. Donald Shelbourne, Indianapolis, IN (US)

(21) Appl. No.: 16/804,088

(22) Filed: Feb. 28, 2020

Related U.S. Application Data
(63) Continuation of application No. PCT/US2018/052104, filed on Sep. 21, 2018.
(60) Provisional application No. 62/561,431, filed on Sep. 21, 2017.
(60) Provisional application No. 62/646,583, filed on Mar. 22, 2018.

(51) Int. Cl. A61H 1/02

(52) U.S. Cl. CPC A61H 1/024; A61H 2201/0157; A61H 2201/1642; A61H 2201/1635; A61H 2201/1276

(57) ABSTRACT

A knee extension apparatus for use to decrease flexure contraction of the knee of the user includes a frame having opposite sides and a handle portion. A first strap is assembled to the frame and extends between opposite sides. A second strap is assembled to the frame and extends between opposite sides. A third strap, also assembled to the frame and extending between opposite sides, is specifically positioned to be proximal to the knee of the user. In order to position the third strap in this location the length of the frame must be extended consistent with the method of use.

### CROSS REFERENCE TO RELATED APPLICATIONS

The present application is a continuation of PCT Application No. US2018/052104 filed Sep. 21, 2018, which claims the benefit of U.S. Provisional Patent Application Ser. No. 62/561,431 filed Sep. 21, 2017 entitled “KNEE EXTENSION APPARATUS AND METHOD OF USE” and U.S. Provisional Patent Application Ser. No. 62/646,583 filed Mar. 22, 2018 entitled “THERAPY APPARATUS AND METHOD OF USE FOR KNEE EXTENSION” which are hereby incorporated by reference in their entirety to the extent not inconsistent.

### BACKGROUND

Knee extension apparata are found in the prior art, including the apparata of U.S. Pat. Nos. 6,962,570; 7,534,213 and 8,343,080. For background and for perspective, each of these issued US patents is expressly incorporated by reference herein.

Also found in the prior art is an apparatus for stretching hamstrings as disclosed in U.S. Pat. No. 7,309,305. This issued US patent is expressly incorporated by reference herein. This incorporation by reference provides both background and a starting point for an explanation and description of the present invention.

The apparatus or structure described in U.S. Pat. No. 7,309,305 (the '305 patent) is specifically constructed and arranged for stretching hamstrings. The size, shape and configuration of the frame and the positioning of the fabric straps of material are all based on this intended manner of use. Any change in sizing or adjustability of the frame of the structure disclosed in the '305 patent still positions one strap adjacent the knee which is distal to the knee. This specific location for this strap is critical to the intended manner of use of the structure disclosed in the '305 patent which is “for stretching hamstrings”.

The present invention envisions modifications and structural improvements to the apparatus which is disclosed in the '305 patent. The design modifications and structural improvements disclosed herein provide a new invention to be used for knee extension therapy. The envisioned design modifications can be made to the structure of the '305 patent or can provide the basis and guidance for a new and original construction for a knee extension apparatus according to the present invention. This knee extension apparatus, as disclosed herein, is for use by a person in order to decrease flexure contraction of the “affected” knee of that person thereby improving knee extension.

### SUMMARY

The knee extension apparatus according to the exemplary embodiment of the present invention includes a frame and three straps extending from one side of the frame to the opposite side of the frame. An optional fourth strap is contemplated for adding strength and rigidity to the handle portion. In use, one strap is to be positioned so that the sole of the user's foot or footwear pushes against it. A second strap supports the user's ankle. The third strap is adjacent the knee and is positioned proximal to the knee. A handle portion of the frame is angled away from the user for ease in grasping by the user, with arms extended, and for exerting a pulling action (of the handle portion) toward the torso or chest of the user. This pulling action causes the third to strap to apply a downward force on the upper surface of the thigh of the user which helps to improve knee extension and helps in decreasing flexure contraction of the affected knee of the user. Use of the disclosed apparatus has the user sitting upright with both legs extended. For clarity, the use of “thigh” herein is intended to refer to that portion of the leg which is between the knee and the hip.

The apparatus disclosed herein may be the result of initial or original manufacturing or may be the result of making modifications to the FIG. 3 (or FIG. 4) structure disclosed and illustrated in the '305 patent. If this patented structure is modified, a frame extension is either incorporated into or assembled into each frame side rail in order to make the frame longer. This is important so as to place or position the third strap proximal to the knee of the user. The apparatus of the '305 patent places the third strap distal to the knee which means between the knee and the ankle. This is a critical difference between the apparatus of the '305 patent and the present invention. A second modification to the apparatus of the '305 patent is to make the third strap wider so that the area of force distribution proximal to the knee is larger. A third modification to the FIG. 3 (or FIG. 4) structure of the '305 patent is to bend the (upright) handle portion of the frame away from the chest or torso of the user by an additional approximately 30 degrees at a minimum, and preferably by an additional approximately 60 degrees. This additional bending of the handle portion away from the chest of the user by approximately 30 to 60 degrees allows the handle portion to be more easily grasped by the user with added arm extension. This modification also provides room or clearance in order for the user to pull the handle portion towards the user in order to apply the desired force on the upper surface of the thigh and thereby help to decrease flexure contraction of the knee of the user and improve knee extension.

### BRIEF DESCRIPTION OF THE DRAWINGS

FIG. 1 is a perspective view of the '305 patent structure (left) alongside a modified apparatus of that structure showing the longer frame, a repositioned and wider strap all according to the present invention.

FIG. 2 is a perspective view of the '305 patent structure of FIG. 1 (in use) showing where the proximal strap is positioned relative to the knee which is distal of the knee.

FIG. 3 is a perspective view of the modified apparatus (in use) showing where the proximal strap is positioned relative to the knee with the longer frame.

FIG. 4 is a perspective view of the '305 patent structure (top-left) alongside the new therapy apparatus according to the present invention.

FIG. 5 is a perspective view of a handle portion with a first bend angle comprising one of the parts of the new therapy apparatus of FIG. 4.

FIG. 5A is a perspective view of the FIG. 5 handle portion with a preferred bend angle.

FIG. 6 is a perspective view of a frame portion comprising one of the parts of the new therapy apparatus of FIG. 4.

FIG. 7 is a perspective view of a representative strap comprising one of four similar straps which are part of the new therapy apparatus of FIG. 4.

FIG. 8 is a diagrammatic side elevational view of a possible modification to the new therapy apparatus of FIG. 4 with a first bend angle for the handle upright.

FIG. 8A is a diagrammatic side elevational view of the FIG. 8 modification with a preferred bend angle.

FIGS. 9A, 9B and 9C are diagrammatic front elevational views of possible alternative constructions for a handle upright which is a part of the modified apparatus of FIG. 8.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present to invention may not be shown for the sake of clarity.

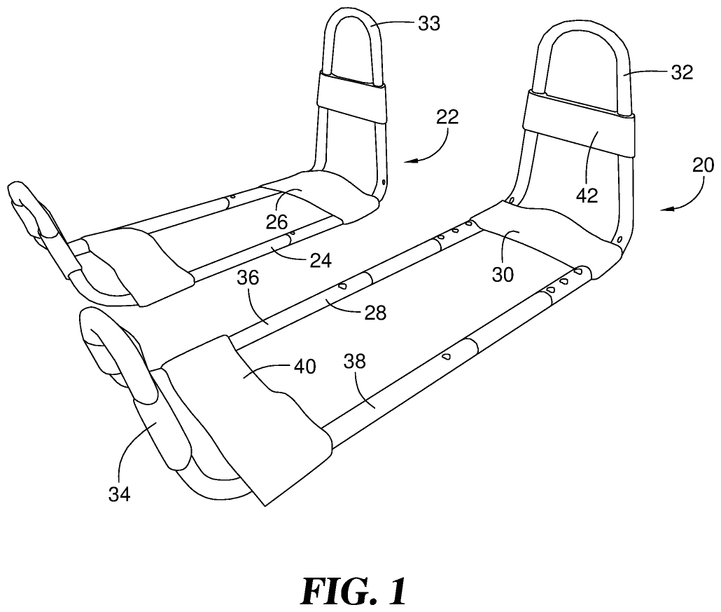

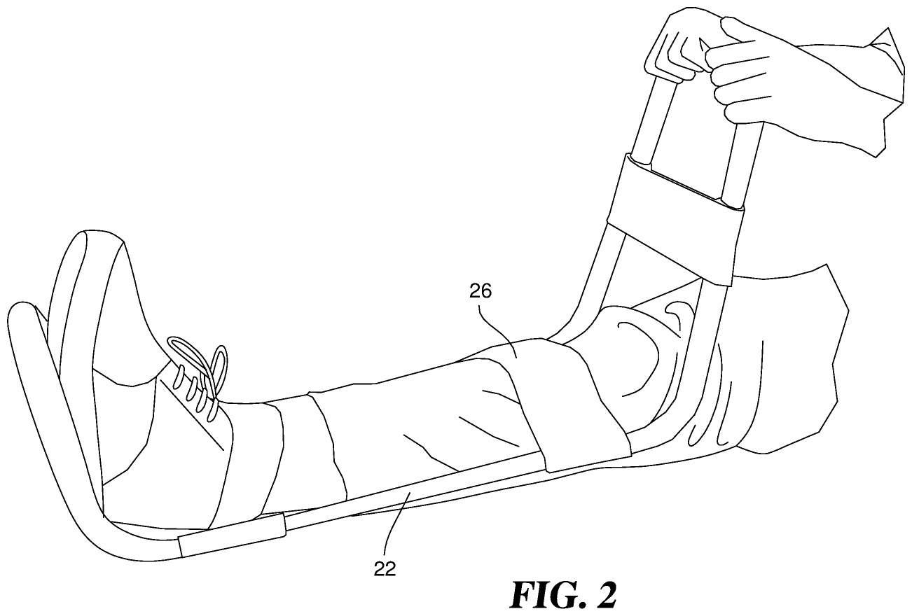

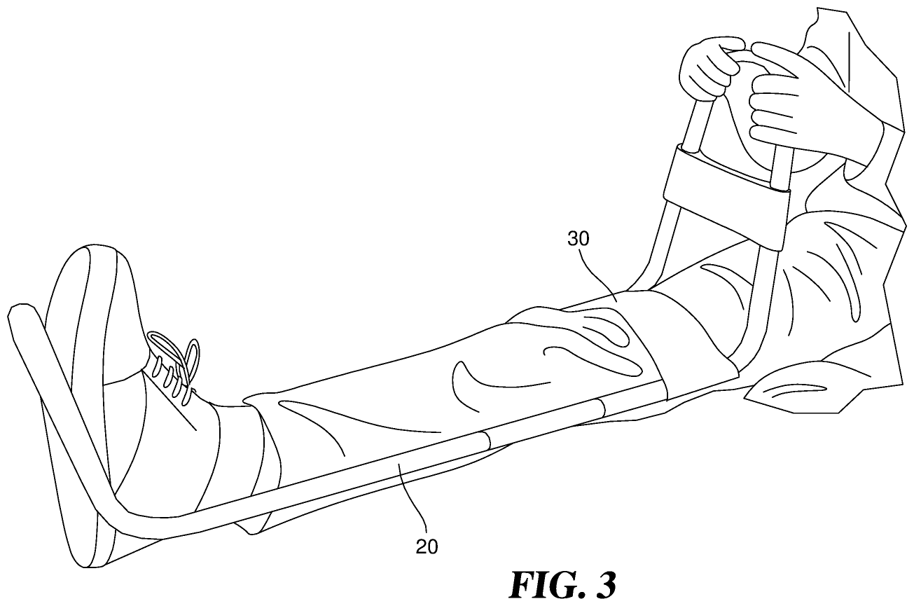

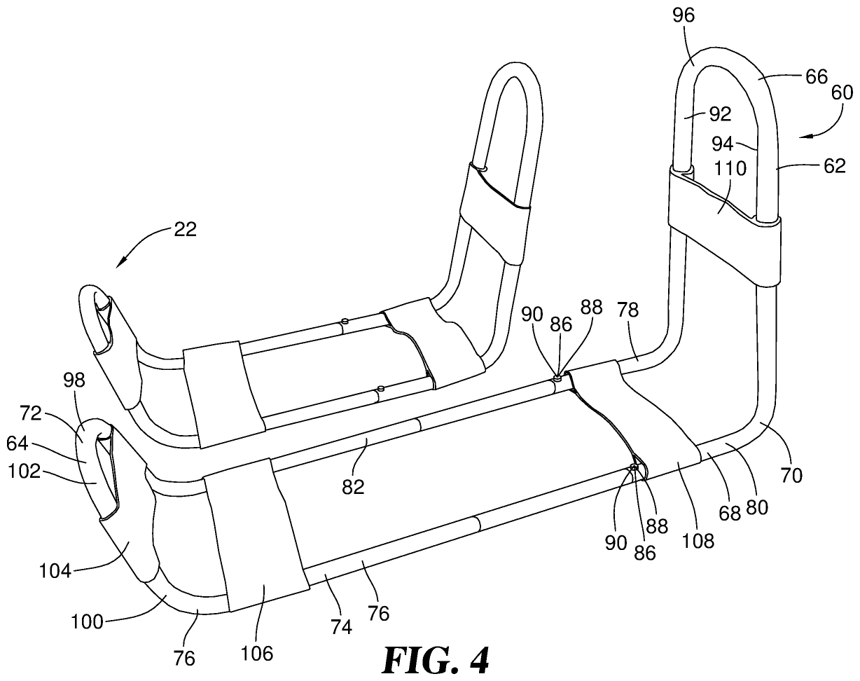

Referring to FIGS. 1 through 3 there is illustrated an extension apparatus 20 according to the present invention. Also illustrated is a structure 22 which generally corresponds to the FIG. 3 (or perhaps FIG. 4) structure of U.S. Pat. No. 7,309,305. Structure 22 is included as it is possible to make modifications to structure 22 in order to create apparatus 20. Preferably apparatus 20 is fabricated as original equipment as this is more efficient and cost-effective. If one elects to make modifications to structure 22 in order to create apparatus 20 these modifications would include increasing the length of the frame 24, widening the strap 26 which is adjacent the knee (i.e. the third strap). Importantly, there is a modification of relocating this third strap from a position below (distal to) the knee to a new position above (proximal to) the knee. The frame length is increased as shown by (new) frame 28 in order to move the position of the third strap 26 from being distal to the knee (see FIG. 2) to its new position which is proximal to the knee (see FIG. 3). The relocated, wider strap 30 provides a larger surface area of force application across the upper surface of the user's leg, proximal to the knee. This wider strap is more effective and more comfortable.

When the length of the frame 24 is increased into frame 28, the handle portion 32 is moved closer to the chest or torso of the user who is using apparatus 20 while sitting upright with both legs extended. In order to facilitate the grasping of the handle portion 32 while having the arms extended, the handle portion 32 is bent away from the user. This is the fourth modification to structure 22 in order to create apparatus 20. The increased bend angle of the handle portion 32 away from the user is a minimum of approximately 30 degrees and preferably approximately 60 degrees as compared to the angled form of the handle 33 of structure 22.

The final design of apparatus 20 with four modifications to structure 22 can also be originally manufactured into that final form. It is contemplated that the final design can be the result of initial or original manufacturing with all of the final form and final features being the result of new fabrication. Whether apparatus 20 evolves from the four modifications to structure 22 or as a result of original manufacturing, the final form is what is important. The final form provides an apparatus which is lightweight, portable, easy to use and effective to decrease flexure contraction of the knee when used properly as part of a therapy protocol for improved knee extension.

Strap 34 of apparatus 20 is secured to opposite sides 36 and 38 of frame 28 and is to positioned to be adjacent the sole of the user's foot or footwear. The strap and the other three straps 40, 30 and 42 are fabricated out of a strong and durable, flexible material, such as ballistic nylon fabric. Strap 40 of apparatus 20 is secured to opposite sides 36 and 38 and is positioned to be below and support the ankle of the user. An optional fourth strap 42 is provided as a means to brace and strengthen the frame 28 in the vicinity of handle portion 32. Straps 34 and 40 should be taut for proper support of the foot and ankle. Strap 30 should have a length with a little slack to be able to extend over the thigh of the user. Strap 42 should be taut as it provides rigidity and strength to handle portion 32.

FIG. 4 provides a further illustration of the FIG. 1 apparatus 20, now incorporating more details of what would be included as part of an original manufacturer for apparatus 20 according to the present invention. Rather than comparing and analyzing the modifications which one might make to structure 22, also shown in FIG. 4, in order to create a new and improved knee extension apparatus, apparatus 60 of FIG. 4 is illustrated and described as a new construction resulting from an original manufacturer.

Apparatus 60 includes a handle portion 62 and a frame portion 64 which are assembled together with a telescoping fit of base portions so that the overall length of apparatus 60 can be selectively adjusted by the user in order to properly “size” apparatus 60 to the particular user.

Handle portion 62 includes a handle upright 66 and a handle base 68. The junction 70 between the handle upright 66 and handle base 68 is curved such that the remainder of the handle upright 66 forms an included angle with the remainder of the handle base 68. At a minimum this included angle should be 90 degrees for at least partial arm extension and preferably 60 degrees for full arm extension. Frame portion 64 includes a frame upright 72 and a frame base 74. The junction 76 between the remainder of frame upright 72 and frame base 74 forms a generally obtuse included angle of approximately 120 degrees.

Handle base 68 includes two substantially parallel, hollow, tubular side rails 78 and 80. Frame base 74 includes two substantially parallel, hollow, tubular side rails 82 and 84. As illustrated, side rail 78 telescopingly slides over side rail 82 and side rail 80 telescopingly slides over side rail 84. In order to make the overall length of apparatus 60 adjustable by the user, side rails 82 and 84 each include a ball detent 86 which is preferably in the form of a spring-biased plunger with a spring-biased protruding ball. Each side rail 78 and 80 includes a plurality of clearance holes 90 which are spaced apart and aligned with the protruding (spring-biased) ball 88 of detent 86. In this manner, the ball 88 is able to engage the selected clearance hole 90 and thereby establish a desired length for apparatus 60. This adjustment using the ball detent and one of the selected clearance holes is performed in the same manner with each side rail 78 and 80 as they respectably slide over the corresponding and cooperating side rails 82 and 84. As would be understood the clearance hole locations and clearance hole spacing is the same in each side rail 78 and 80. Similarly, the location of each ball detent 86 is the same in side rail 82 and side rail 84. In lieu of using a ball detent 86, the hole location for each ball detent 86 can be used as a through hole for the use of threaded fasteners for fixing the frame length and for adjustability.

In order to change the desired length of apparatus 60, the user simply depresses each spring-biased ball 88 and then telescopingly slides the corresponding side rail 78, 80 to a new clearance hole 90 location into which the released ball 88 moves for fixing the overall length of apparatus 60. In the exemplary embodiment there are four clearance holes 90 in each side rail which are equally-spaced and approximately one inch (2.54 cm) apart.

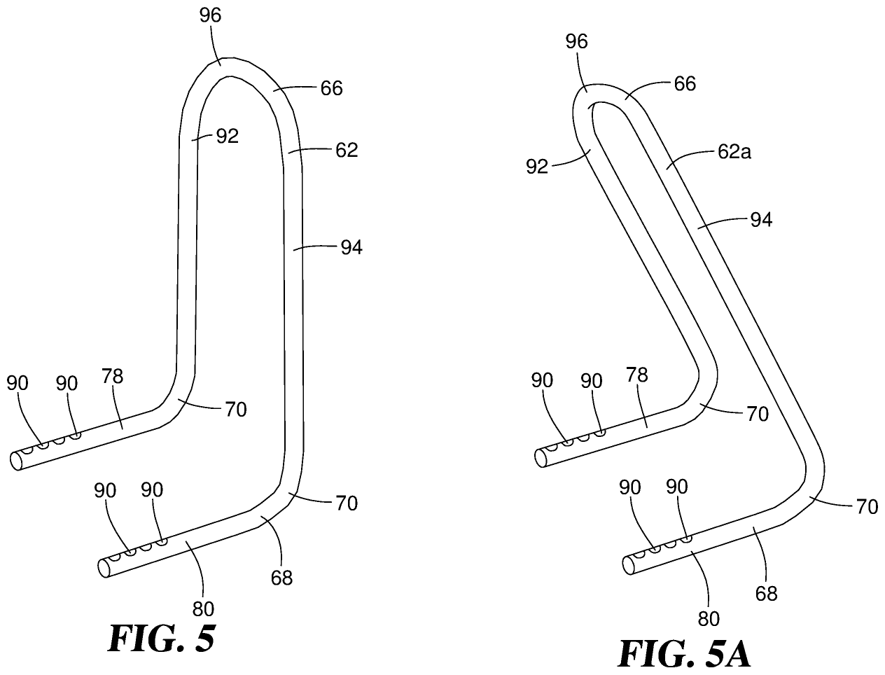

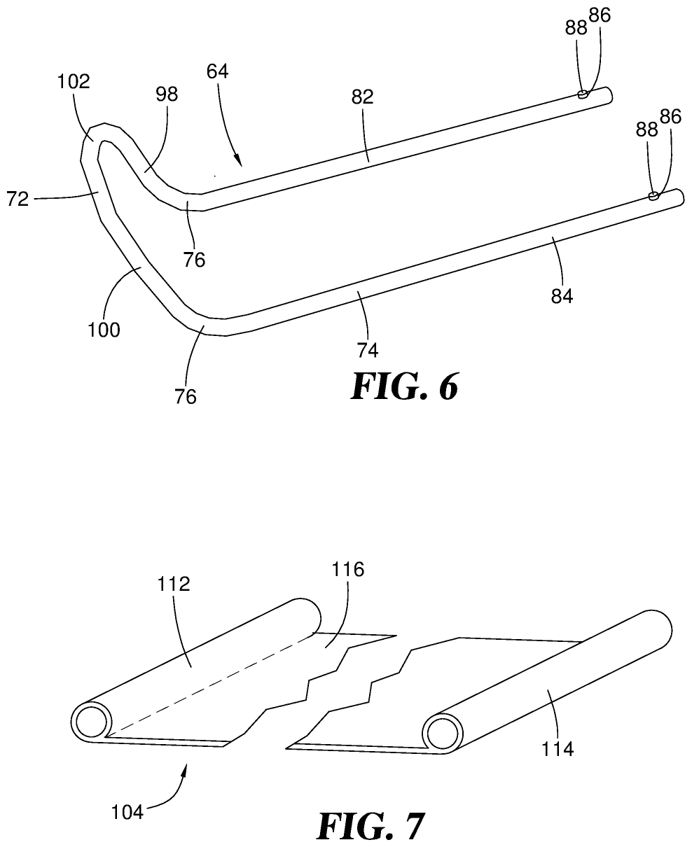

Above junction 70 the tubular sides 92 and 94 handle upright 66 are each substantially straight and are substantially parallel to each other. The curved top 96 of handle upright 66 is preferably part-circular. In the case of frame upright 72, its tubular sides 98 and 100 taper slightly in an inward direction converging towards the curved top 102. Handle portion 62 is illustrated in FIG. 5 with an included angle of approximately 90 degrees. Handle portion 62a is illustrated in FIG. 5A with the preferred included angle of approximately 60 degrees. Frame portion 64 is illustrated in FIG. 6.

Each strap 104, 106, 108 and 110 is sized for the portion of apparatus 60 where it will be positioned. Each strap 104, 106, 108 110 is fabricated from a flexible, strong, synthetic material, such as ballistic nylon. The free ends of each strap (see FIG. 7) are formed into a cylindrical sleeve 112 and 114 and then stitched to the intermediate panel 116 which extends between those two cylindrical sleeves. The FIG. 7 strap 104 is representative of all four straps. Prior to telescoping together the handle portion 62 in the frame portion 64, each strap is assembled onto its corresponding portion by sliding each sleeve 112, 114 over the corresponding tubular member. From a size perspective, including the length of each strap 104-110, straps 104 106 should be taut when properly assembled. This will enable proper support of the foot and ankle. Strap 108 on the other hand should have some slack as the strap needs to extend and lay over the upper surface of the thigh of the user (proximal to the knee). Strap 110 should also be taut as it provides added strength and rigidity to handle upright 66.

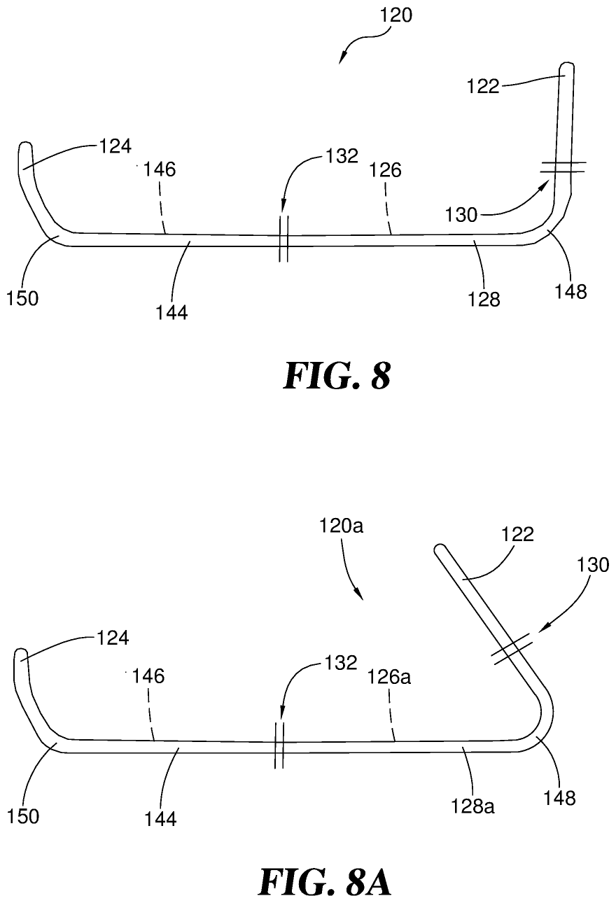

It is envisioned that as one possible modification to apparatus 60, the handle portion 62 (and preferably handle portion 62a) and frame portion 64 can be reconfigured into four separate parts. FIG. 8 illustrates in diagrammatic form by way of apparatus 120 where apparatus 60 might be separated for this modified construction. FIG. 8A illustrates in diagrammatic form the points of separation for the preferred construction with handle portion 62a (60 degree included angle). All other sizes, shapes and components remain essentially the same between apparatus 60 and apparatus 120, including the ball detent 86 construction for telescoping length adjustment, the clearance holes 90 and the four straps 104, 106, 108 and 110.

With continued reference to FIGS. 8 and 8A, apparatus 120 includes handle upright 122, frame portion 124 and connecting side rails 126 128, one on each side of apparatus 120 and arranged generally parallel to each other extending from their point of connection with handle upright 122 to their point of connection with frame portion 124. Double line 130 represents one acceptable or suitable location for the telescoping assembly between handle upright 122 and each connecting side rail 126 and 128. The handle upright 122 preferably includes the ball detent 86 and each connecting side rail 126 128 preferably includes the series of equally-spaced clearance holes 90 for adjustably connecting these parts. In this manner and with this construction the height of the handle portion which is handle upright 122 is selectively adjustable by the user.

Double line 132 represents one acceptable location for the telescoping assembly between frame portion 124 and each connecting side rail 126 and 128. Frame portion 124 preferably includes the ball detent 86 and each connecting side rail 126 and 128 preferably includes a series of equally-spaced clearance holes 90 for adjustably connecting these parts together. In this manner and with this construction the overall length of apparatus 120 can be selectively adjusted by the user of apparatus 120.

One aspect of creating the construction of apparatus 120 is the ability to adjust the height of the handle upright 122 which essentially adjusts the overall height of the handle portion. This type of adjustment may be beneficial in terms of enabling the user of apparatus 120 to to “customize” the overall size of apparatus 120 to fit that particular user. Although either apparatus 60 or 120 is comparably adjustable as to overall length, apparatus 60 as configured does not provide height adjustment for the handle portion.

Another benefit seen from the construction of apparatus 120 is that the locations of double lines 130 and 132 can be selected so as to manage the overall size of the four main component parts. As noted, those two double line locations are intended to identify where the telescoping inner fit between the various components occurs. By carefully selecting the locations for those points of connection, it is possible to control or manage, at least to some extent, the overall size of these four primary component parts. In turn, this would enable a smaller overall package in terms of product display and shipping. A further option from this construction is represented by apparatus 120 is that a “big and tall” size could be provided by simply swapping out the two side rails 126 and 128 for much longer connecting side rails. While the current adjustment is believed to be adequate for the vast majority of potential users, there are always those circumstances where a particularly tall individual would not find apparatus 120 suitable based on its overall length.

The FIG. 8 illustration for an optional construction of apparatus 60, now shown as apparatus 120, includes an approximate 90 degree included angle at junction 148. This is the recommended minimum included angle and preferably this included angle will be approximately 60 degrees, as shown in FIG. 8A. The only component parts which change between the FIG. 8 construction and the FIG. 8 a construction are the two side rails 126 and 128 (FIG. 8), now identified as 126a and 128a in FIG. 8A. The only difference between these two pairs of side rails is the included angle which is defined by the amount of bend at junction 148.

The included bend angle of structure 22 is believed to be approximately 120 degrees. When changing to apparatus 20 or apparatus 60 or apparatus 120, the overall length of the apparatus increases. This allows strap 108 to be positioned proximal to the knee. However, this overall increase in length brings the handle of structure 22 too close to the chest of the user for enabling some degree of arm extension. Arm extension is important for the user to be able to easily and effectively pull the handle portion or handle upright toward the user's chest. Ideally, the user's arms would have full extension and for this to occur, the preferred included angle at junction 148 is 60 degrees. This preferred included angle of 60 degrees combined with an appropriate height or length of the handle portion above junction 148 positions the top (curved) section of the handle portion over the user's tibia, distal of the knee. Constructing apparatus 20, apparatus 60 and apparatus 120 with this particular positioning of the top section of the handle portion enables full arm extension for the user when grasping the top section of the handle portion. This is the preferred manner of use for apparatus 20, apparatus 60 and apparatus 120. While the description which follows focuses on the FIG. 8 construction, this description is fully applicable to the FIG. 8A construction.

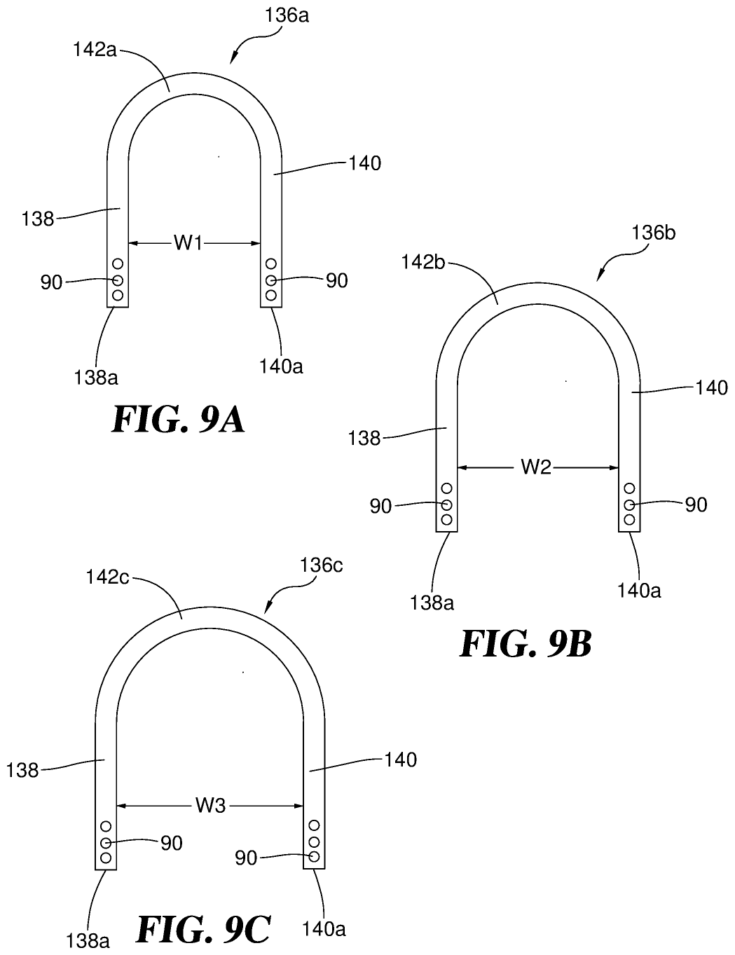

Referring now to FIGS. 9A, 9B and 9C, a further modification or variation in design is shown which is permitted by the construction of apparatus 120. In FIGS. 9A, 9B and 9C three different sizes of handle uprights 136a, 136b and 136c are illustrated. These three sizes (width variations) of handle uprights generally correspond to the construction of handle upright 122 which has a telescoping fit with each of the two connecting side rails 126 and 128. As would be understood, the two points of telescoping connection for each connecting side rail 126 and 128 could position the ball detent 86 in either member and the plurality of clearance holes 90 in the other member. For example, handle uprights 136a, 136b and 136c could either include the plurality of clearance holes which is what is now illustrated or in the alternative those clearance holes could be placed in the connecting ends of each connecting side rail 126 and 128 in which case the free ends of each handle upright would include the ball detent component. Replacing the ball detent component with a clearance hole and the use of threaded fasteners remains an option. This alternative in terms of the telescoping fit for the two connecting side rails 126 and 128 also applies to the point of connection with frame portion 124.

With continued reference to FIGS. 9A, 9B and 9C the size variation between handle uprights 136a, 136b and 136c is limited to the axial centerline to axial centerline distance or width of the generally parallel tubular sides 138 and 140. The actual clearance width between the inner and facing surfaces of each tubular side 138 and 140 is shown as widths W1, W2 and W3, respectively. Generally following the construction of handle upright 122, each top section 142a, 142b, 142c is part-circular. Accordingly, the width variations are reflected by a larger part-circular top section, larger in terms of the radius size.

The free ends 138a and 140a of each tubular side 138 and 140 include three clearance holes 90 as one option for the height adjustability as described for handle upright 122. As such it is intended that the free end of tubular side 138 slide over the corresponding free end of connecting side rail 126 and engage with the ball detent 86 which is assembled into side rail 126. Likewise, the free end of tubular side 140 is constructed and arranged to slide over the free end of connecting side rail 128 and engage with its ball detent 86. The construction and arrangement of side extensions 144 and 146 of frame portion 124 generally correspond to the construction and arrangement side rails 82 and 84.

The use of connecting side rails 126 and 128 provides the option of shortening the extended length of side rails 82 and 84 of frame base 74 for the construction of frame portion 124. This shortening in overall length may provide for more compact packaging when storing and/or shipping. However, the substantially parallel arrangement of side rails 82 and 84 is maintained for side extensions 144 and 146, regardless of any length changes or differences. As will be noted, connecting side rails 126 and 128 are substantially straight members until reaching the curved junction at which point the side rails curve upwardly also with substantially straight portions forming a substantially right angle for the included angle at the junction. Accordingly, the free ends of these connecting side rails 126 and 128 are substantially parallel to each other as they extend from frame portion 124 and arrive at each handle upright 136a, 136b and 136c for a telescoping fit and detent ball assembly. In this manner it will likely be the width of the tubular side rails 138 and 140 which dictate and influence, if not control, the width or separation between the two connecting side rails 126 and 128, at least in the vicinity of junction 148. This width or separation at this location (junction 148) needs to be a little wider than the width of the thigh of the user as the thigh is to be positioned between the connecting side rails with the strap at that location extending over the top of the thigh, adjacent to and proximal of the affected knee.

If the initial clearance width between the inner surfaces of the two connecting side rails 126 and 128 is set at approximately 8.0 inches (20.32 cm) for the small to average user, then this clearance width would correspond to the width spacing of handle upright 136a (the clearance width W1 between the generally parallel tubular sides 138 and 140). The telescoping fit and ball detent securement of the handle upright 136a and the connecting side rails 126 and 128 would not cause any lateral or width deflection of those two connecting side rails 126 and 128 as all sizes would be comparable. However, that width can change by the outward deflection of the two connecting side rails 126 and 128 to obtain an increased clearance width which would be more suitable for larger users with bigger/wider thighs.

Referring now to FIG. 9B, the width dimension W2 between the inner and facing surfaces of the two tubular sides 138 and 140 is approximately 1.0 inch (2.54 cm) wider than the to corresponding width dimension W1 of those two tubular sides of FIG. 9A. This means that the two connecting side rails 126 and 128 need to deflect laterally outwardly a total of 1.0 inches (2.54 cm) for the described telescoping assembly to be achieved. The pivot or hinge point for this outward deflection of the two connecting side rails is at junction 150 of frame portion 124. The result is a wider clearance width of approximately 9.0 inches (22.86 cm) in the vicinity of junction 148 for user's with slightly larger size.

In the case of the FIG. 9C construction, the width dimension between its two tubular sides 138 and 140 (W3) is increased again over the FIG. 9B handle upright 136b clearance width by another approximately 1.0 inches (2.54 cm). This further clearance width thus increases the overall clearance width of the FIG. 9C construction to approximately 10.0 inches (25.40 cm) for users with still larger thighs. As would be understood, the sizes are for reference only. The point being made is that size variations for the handle uprights 136a, 136b and 136c is an option. By causing outward deflection of the connecting side rails 126 and 128, the clearance width in the vicinity of the user's thigh can be changed.

As described, four straps 104, 106, 108 and 110 are preferably used as part of apparatus 60. Four straps are also preferably used with apparatus 120. When the base or standard width size of apparatus 120 with handle upright 136a (see FIG. 9A) is provided, this apparatus 120 includes the same four straps 104, 106, 108 and 110 which are used in the same position and in the same manner as for apparatus 60. The size width of apparatus 120 and the size width of apparatus 60 are essentially the same. When either of the wider handle uprights 136b or 136c are provided as a part of apparatus 120, slightly wider straps for straps 108 and 110 are included. The slightly wider straps correspond in their increased length (sleeve 112 to sleeve 114) to the increased thigh clearance width provided when either handle upright 136b or 136c is assembled to the corresponding connecting side rails 126 and 128.

Apparatus 60 and apparatus 120, including all size variations, are intended to be used in the same manner. The optional construction of apparatus 120 which has four parts providing the frame and handle, as contrasted to two parts, enables more compact packaging options and the option for varying the clearance width size. However, the final assembly of apparatus 120 is intended to be used in the same manner as the final assembly of apparatus 60.

Currently, there are believed to be numerous procedures performed to try and address knee and leg pain based on a misunderstanding and/or on a missed diagnosis. Often the to procedure begins with an MRI of the knee which may show some degree of damage such as a minor meniscus tear, particularly with older individuals and athletes. If this minor meniscus tear is diagnosed in error as the reason for the knee pain, the knee may be “scoped” (arthroscopic surgery). In reality many of the “knee pain” patients may only have a knee extension issue which can be addressed by the use of either apparatus 60 or apparatus 120 without surgery. For purposes of this discussion reference will be made to apparatus 120 and this reference is intended to include all size variations of apparatus 120 as well as include apparatus 60.

When treating the pain by the use of apparatus 120, the first step is to have the patient (i.e. the user of the apparatus) sit upright with both legs extended, preferably on an examination table or at least a rigid surface. The next step is to place the leg with the “unaffected” knee, what will be referred to herein as the “good leg”, in apparatus 120. Once the good leg is properly positioned, the next step is to have the user of apparatus 120 grasped the handle upright with both hands and pull the handle upright toward the chest or torso of the user. This pulling action will elevate the heel of the good leg above the upper surface of the table or rigid support surface. The amount of elevation or clearance of the heel above the upper surface of the table is visually measured by the user and may be more accurately measured by the use of a ruler. This clearance or amount of elevation of the heel above the upper surface of the table becomes the target elevation for the leg with the “affected” knee.

With the target elevation in mind, the user takes the good leg out of apparatus 120 and places the other leg with the “affected” knee in apparatus 120. Once this other leg is properly positioned in apparatus 120 the user pulls the handle upright towards the chest or torso, as before. The affected knee may have an extension issue and in which case, the heel will not be raised or lifted to the same height above the table and will be short of the target elevation or height.

It is preferable that this initial assessment and use of apparatus 120 be conducted in a physician's office or in a physical therapy facility. This will provide the user with an understanding of apparatus 120 and will establish the desired or target height for heel elevation which relates directly to the extension. Following this initial assessment and understanding of the work to be done, the user takes apparatus 120 home and continues the process of improving knee extension. The user can conveniently sit upright on a comfortable, though firm surface, such as a rug or mat and place the leg with the affected knee in apparatus 120. Once the leg is to properly positioned, the user pulls back on the handle upright and works to improve knee extension. This home use can be done daily or at any desired interval or frequency and the pulling force exerted by the user should be as high as the user feels comfortable with while still feeling the stretching due to knee extension. Gradually, with continued use and increasing the pulling force as knee extension improves, the user should be able to see the heel of the leg with the affected knee lifting higher and higher above the support surface on its way to the target elevation of the heel of the good leg. At any time the user wishes to check the progress being made with improved and increased knee extension relative to the target heel elevation, apparatus 120 can simply be used on the good leg.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A knee extension apparatus for use to decrease flexure contraction of the knee of the user comprises:
a frame having a pair of frame portions along opposite sides of a user's leg;
a handle portion extending up from said frame;
a surface to contact the sole of the user's foot or footwear;
a first strap extending between said opposite sides of said frame, said first strap being located proximal of said surface and distal of the user's knee;
a second strap extending between said opposite sides and proximal to the user's knee;
wherein upon pulling on said hand portion towards the user's torso said frame imparts a downward force on said second strap at a location on said users leg that is proximal to the user's knee.

2. The apparatus of claim 1 wherein said surface is a third strap the contacts the user's foot or footwear.

3. The apparatus of claim 2 wherein said handle portion is telescopically connected to said frame via a pair of spring bias detents and holes correspondingly in said pair of frame portions.

4. The apparatus of claim 3 wherein said hand portion extends upwardly from said frame at an include angle of between 60 and 90 degrees such that the handle provides arm extension away from the user's torso to facilitation pulling on said handle.

5. The apparatus of claim 3 wherein said hand portion extends upwardly from said frame at an include angle of about degrees such that the handle provides arm extension away from the user's torso to facilitation pulling on said handle.

6. The apparatus of claim 4 wherein said frame includes a pair of frame extensions located between said first strap and said second strap, each of said frame extensions being tubular and having a pair of spring bias detents and holes correspondingly in said pair of frame portions, whereby said frame extensions extend the distance between said first and second straps with said second strap proximal to the user's knee.

7. The apparatus of claim 6 and further comprising a fourth strap on said handle and providing strength and rigidity to said handle.

8. A method using the apparatus of claim 1, said method comprising:
diagnosing a user's knee using an MRI;
thereafter, having the user use the apparatus of claim 1 to apply downward force on their leg via said second strap proximal to their diagnosed knee to decrease flexure contraction of that knee.

9. The method of claim 8 without surgery on the user's diagnosed knee.

10. The apparatus of claim 1 wherein said hand portion extends upwardly from said frame at an include angle of between 60 and 90 degrees such that the handle provides arm extension away from the user's torso to facilitation pulling on said handle.

11. The apparatus of claim 1 wherein said hand portion extends upwardly from said frame at an include angle of about degrees such that the handle provides arm extension away from the user's torso to facilitation pulling on said handle.

12. The apparatus of claim 4 wherein said frame includes a pair of frame extensions located between said first strap and said second strap, each of said frame extensions being tubular and having a pair of spring bias detents and holes correspondingly in said pair of frame portions, whereby said frame extensions extend the distance between said first and second straps with said second strap proximal to the user's knee.

13. The apparatus of claim 1 and further comprising a fourth strap on said handle and providing strength and rigidity to said handle.

14. A method using the apparatus of claim 1, said method comprising:
diagnosing a user's knee using an MRI;
thereafter, having the user use the apparatus of claim 1 to apply downward force on their leg via said second strap proximal to their diagnosed knee to decrease flexure contraction of that knee.

15. The method of claim 14 without surgery on the user's diagnosed knee.
